(19) United States
(12) Patent Application Publication
(10) Pub. No.: US 2024/0049361 A1
(43) Pub. Date: Feb. 8, 2024

(54) CLEANING DEVICE AND METHOD FOR CONTROLLING A CLEANING DEVICE

(71) Applicant: Carl Freudenberg KG, Weinheim (DE)

(72) Inventors: Denys MAIIER, Rimbach (DE); Christian STENGLEIN, Frankfurt am Main (DE)

(21) Appl. No.: 18/257,300

(22) PCT Filed: Dec. 2, 2021
(86) PCT No.: PCT/EP2021/083952

§ 371 Date: Jun. 14, 2023

(30) Foreign Application Priority Data
Dec. 15, 2020 (DE) 10 2020 133 481.8

(51) Int. Cl. H05B 1/02; A47L 11/40

(52) U.S. Cl. CPC H05B 1/0283; A47L 11/4011; A47L 11/4002; A47L 11/4083; A47L 11/4086

(57) ABSTRACT

A cleaning appliance including a cleaning element, a liquid container, an electrically operated heater, and a controller for controlling the heater. The controller has an electronic circuit, and the electronic circuit is structured such that a thermal behavior of the heater is modeled therein. A temperature characteristic of the heater is represented by a voltage characteristic in the electronic circuit.

### CROSS REFERENCE TO RELATED APPLICATIONS

This application is a U.S. National Phase application under 35 U.S.C. § 371 of International Application No. PCT/EP2021/083952, filed on Dec. 2, 2021, and claims benefit to German Patent Application No. DE 10 2020 133 481.8, filed on Dec. 15, 2020. The International Application was published in German on Jun. 23, 2022 as WO 2022/128505 A1 under PCT Article 21(2).

### FIELD

The invention relates to a cleaning appliance having a liquid container, an electrically operated heating means for heating a liquid, and having a control unit for controlling the heating means. The invention also relates to a method for controlling such a cleaning appliance.

### BACKGROUND

Household appliances that have a liquid container and heating means are, for example, cleaning appliances such as steam cleaning appliances, irons, steam cookers or coffee machines.

A very wide variety of cleaning appliances are known for cleaning surfaces such as, for example, floors. A particularly effective method for cleaning hard surfaces is the use of steam. Thus, for example, WO 2016/046554 A1 describes a steam cleaning appliance that has a steam generator and a cleaning element. Steam is applied in the region of contact between the cleaning element and the surface to be cleaned. In order to heat the water present in a container and to generate steam, the steam generator has a heating means such as, for example, a boiler.

The cleaning appliance can only be used for cleaning when the operating temperature has been attained and steam is generated. For this purpose, it is known in the prior art to activate the heating means for a fixed time interval after each switching-off, or deactivation, of the cleaning appliance and to supply it with electric current.

A disadvantage of this is that, for the operator, the general heating without consideration of the actual need results in unnecessary wait times. A further disadvantage is the waste of energy associated with unnecessary heating.

From the prior art, it is also known in principle to provide household appliances with sensors for the purpose of monitoring and controlling them. Thus, it is also possible to provide the household appliance with a temperature sensor and to monitor the boiler temperature, and thus indirectly determine the water temperature.

Direct determination of the water temperature is rare in practice, as implementing this is much more complicated. The indirect or direct monitoring of the water temperature would make it possible to activate the heating means only when necessary. However, a disadvantage of such a solution is that the leads of the sensor need to be thoroughly insulated. The leads of the sensor in the region of the boiler would have to be thermally stable, i.e. a more expensive material with a high melting temperature would have to be used. Otherwise, once the leads have melted, there would be a risk of short-circuits. Such a solution is therefore associated with greater complexity in the structure of the household appliance, as well as with higher costs.

### SUMMARY

In an embodiment, the present disclosure provides a cleaning appliance comprising a cleaning element, a liquid container, an electrically operated heater, and a controller for controlling the heater. The controller has an electronic circuit, and the electronic circuit is structured such that a thermal behavior of the heater is modeled therein. A temperature characteristic of the heater is represented by a voltage characteristic in the electronic circuit.

### BRIEF DESCRIPTION OF THE DRAWINGS

FIG. 1 shows a diagram comparing a heating means and its model;

FIG. 2 shows a comparison of a temperature characteristic curve of a heating means and a voltage characteristic curve of a model; and

FIG. 3 shows an embodiment of an electronic circuit.

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

### DETAILED DESCRIPTION

In an embodiment, the present invention provides a cleaning appliance and a method for controlling a cleaning appliance, with unnecessary activation of the heating means being avoided as far as possible and the structure of the cleaning appliance not being made more complicated, in order thus to rectify, at least partially, the disadvantages of the prior art.

According to an embodiment of the invention, it has been found to be advantageous to provide an electronic circuit in which the thermal behavior of the heating means is modeled.

The cleaning appliance is equipped with a cleaning element, a liquid container, an electrically operated heating means, in particular having a steam generator for heating a liquid, and with a control unit for controlling the heating means. The cleaning appliance is connected, for example, to a voltage source such as a domestic electrical socket. According to an embodiment of the invention, the control unit has an electronic circuit, and the electronic circuit is structured in such a manner that the thermal behavior of the heating means is modeled in the circuit. More precisely: it is not the entire heating means that is modeled, but only its thermal behavior, for which reason the term emulation may be used. The temperature characteristic of the heating means over time (ΔT/t), and thus indirectly the temperature characteristic of the liquid, is represented by a voltage characteristic of the voltage in the electronic circuit over time (ΔU/t). The temperature characteristic specific to the heating means during energy supply and following completion of energy supply is referred to here as thermal behavior, which can be represented in a thermal model.

Such a cleaning appliance has the advantage that an assessment can be made of the temperature prevailing in the heating means, and controlling of the cleaning appliance can be effected in dependence on this. The cleaning appliance may be, for example, a steam cleaning appliance or a floor cleaning appliance for floor cleaning, and the cleaning element may be embodied as a textile mop.

It is provided that the electronic circuit is embodied in hardware and the electronic circuit comprises various electronic components, at least one electric energy store. The electric energy store may store energy capacitively, inductively or chemically, for example. Capacitors are known as capacitive energy stores, coils are known as inductive energy stores, and rechargeable batteries, or accumulators, are known as chemical energy stores. If at least one capacitor is used, electrical resistors may also be used together with it, so that a so-called RC element is formed. The at least one capacitor and the at least one resistor in this case are selected in such a way that the characteristic of the voltage in the electronic circuit over time forms an electronic proxy model of the thermal behavior of the heating means. If the heating process and the cooling process have the same temperature characteristics, a resistor may also be provided in the electronic circuit for representing the temperature characteristics in the above-mentioned exemplary embodiment of the RC element, in addition to a capacitor. If the heating process and the cooling process have different temperature characteristics, a resistor in the charging circuit and another resistor in the discharging circuit may be provided, in addition to a capacitor, in the above-mentioned exemplary embodiment. Then there is an RC element for the heating process and an RC element for the cooling process. The resistors in this case may be realized as electronic components. Alternatively, one of the resistors could also be formed by the internal resistance of the electronic circuit.

If the cleaning appliance is operated with a.c. voltage (e.g. by being connected to a domestic electrical socket with mains voltage), at least one electric rectifier may also be used in the electronic circuit.

Alternative designs using an RL element (electrical resistors and coil) are also possible. In addition, the use of a rechargeable battery and resistors or a microcontroller (battery-supported IC) is also conceivable.

However, the alternative of the RC element is preferred because it is a particularly simple, cost-effective and robust solution.

In a preferred embodiment of the cleaning appliance, the electrical power, the thermal insulation of the heating means and the specific heat storage capacity of the heating means, which all together determine the thermal behavior of the heating means, are represented in the electronic circuit, the heating process and the cooling process of the heating means being represented in an electronic proxy model in the electronic circuit, i.e. the possible temperature characteristic over time is represented. The specific heat storage capacity is also referred to as the specific thermal capacity. The electrical power of the heating means substantially determines the heating process, and the thermal insulation and specific heat storage capacity of the heating means substantially determine the cooling process. Since the heating process and the cooling process normally have different temperature characteristics, different electronic components may be used in the electronic circuit to represent the temperature characteristics. Thus, in the above-mentioned exemplary embodiment of the RC element, in addition to a capacitor, a resistor may also be provided in the charging circuit and another resistor in the discharging circuit.

In an embodiment of the cleaning appliance, the electronic circuit is designed as a PT1 element.

The property of the PT1 element is that, in case of an abrupt change in an input voltage (upon the cleaning appliance being switched on or off), the output voltage (voltage in the electronic circuit) follows this step change, but with a delay and, in its characteristic, according to an exponential function that has a time constant τ. If an RC element is used, the time constant is determined as τ=R·C. The PT1 element may also be embodied, for example, as a first-order low-pass filter.

An alternative PT1 element is an RL element. Its time constant is calculated as τ=L/R.

An embodiment of the invention also relates to a method for controlling a cleaning appliance as described above, wherein the heating means and the electronic circuit can be supplied with energy from an electrical power source, wherein the electronic circuit is always supplied with voltage when the heating means is also supplied with voltage.

In an embodiment, the method for controlling comprises the following steps:
a) when the cleaning appliance is activated, e.g. when it is switched on or connected to a power source, the actual voltage in the electronic circuit is checked,
b) if the voltage is below a limit voltage Uₘᵢₙ that corresponds to a limit temperature Tₘᵢₙ of the heating means, e.g. 110° C., the heating means is supplied with power to heat the liquid. Thus, the heating means preheats the liquid.

Such a method has the advantage that preheating is effected only when necessary. On the one hand, this saves energy. On the other hand, it reduces the amount of time that the operator has to wait until the cleaning appliance is ready for use.

In a first design variant of the method, in step b), if the voltage is below the limit voltage Uₘᵢₙ, the heating means is supplied with power for the duration of a fixed time interval. This may be—depending on the capability of the heating means—for example a time interval of 10 to 20 seconds.

In a second design variant of the method, in step b), if the voltage is below the limit voltage Uₘᵢₙ, the heating means is supplied with power for the duration of a variable time interval, the time interval deriving from the time that is expected until a setpoint voltage Uₘₐₓ is attained in the electrical circuit. The setpoint voltage in this case corresponds to a setpoint temperature Tₘₐₓ of the heating means, e.g. 130° C. In addition to the electrical power and the specific thermal capacity of the heating means, the condition of the heating means and the ambient conditions of the heating means may also be included in the determination of the time interval. The condition may be, for example, an actual or calculated degree of calcification of heating elements of the heating means. The calcification depends on the water hardness of the water used in the cleaning appliance and on the frequency of descaling by the user. The ambient conditions may be, for example, the ambient temperature and/or the air pressure in the environment.

After the heating means has been supplied with power, the actual voltage in the electrical circuit is then checked again, and if the voltage is below a setpoint voltage Uₘₐₓ, the heating means is supplied with power for the duration of a variable time interval. This process may be referred to as intermediate heating. The time interval in this case derives from the time that is expected until the setpoint voltage Uₘₐₓ is attained.

As an alternative to this intermediate heating, cooling down may also be deliberately accepted:

In this case, after a setpoint voltage Uₘₐₓ has been attained, the heating means is not supplied with power for the duration of a variable interval. The time interval in this case derives from the time that is expected until the setpoint voltage Uₘᵢₙ is attained.

In an embodiment of the method for controlling a cleaning appliance, in a next step a release signal may be generated for the operator, to signal that the cleaning appliance is ready for use. The release signal may be acoustic, optical or haptic.

Thus, for example, a warning light may be extinguished, a green signal may be illuminated, or a signal tone may sound.

Embodiments of the invention described and the described advantageous developments of the invention also constitute in combination with one another—insofar as this is technically expedient—advantageous developments of the invention.

In respect of further advantages and advantageous designs of embodiments of the invention with regard to construction and function, reference is made to the dependent claims and the description of exemplary embodiments with reference to the accompanying figures.

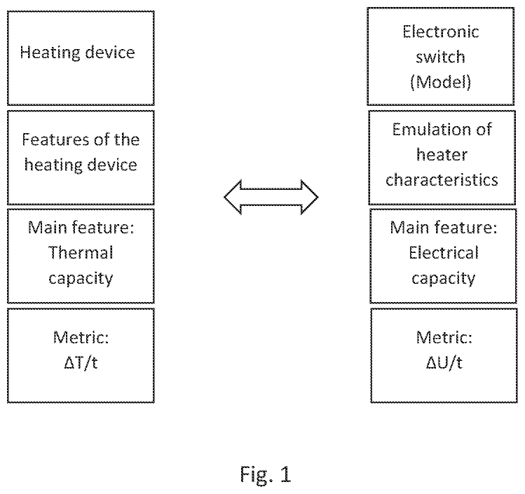

FIG. 1 shows a diagram comparing the heating means and its model, namely the electronic circuit.

In an embodiment, the invention provides a representation of the heating means by an electronic circuit as a model. The features of the heating means are represented by an emulation of features of the heating means. The relevant main feature of the heating means in this case is its thermal capacity. This is represented by the capacitance as the main feature of the electronic circuit. While the measured variable of the thermal capacity is ΔT/t, i.e. the temperature characteristic over time, the measured variable of the capacitance is ΔU/t, i.e. the voltage characteristic over time. The temperature characteristic or voltage characteristic, may be represented in temperature characteristic curves or voltage characteristic curves, respectively. The electronic circuit as a model in this case is structured in such a way that the voltage characteristic curve of the model corresponds to the temperature characteristic curve of the real heating means.

FIG. 2 shows a comparison of the temperature characteristic curve of the heating means and the voltage characteristic curve of the model, i.e. the electronic circuit.

The temperature characteristic curve is represented in the upper diagram. In the period t=0 to t₁, the heating means heats up: the heating means is supplied with power and the liquid is heated up. It is heated until a setpoint temperature Tₘₐₓ is attained. After this, the cleaning appliance can be used by the operator. This happens in the period t₁ to t₂. During this period, the setpoint temperature Tₘₐₓ is maintained. If the cleaning appliance is switch off (time point t₂) and the heating means is disconnected from the power supply, the heating means cools down. This is illustrated by the falling temperature curve. At the time point t₃, for example, the heating means has the temperature Tₘᵢₙ. After that, the heating means cools down further and further until it attains ambient temperature. τ=0 therefore does not mean 0° C., but ambient temperature.

The characteristic curve of the voltage in the electronic circuit is similar, as can be seen from the lower curve:

In the period t=0 to t₁, the electronic circuit is charged: voltage is applied to the electronic circuit and a capacitor in the electronic circuit, for example, is charged. It is charged until a setpoint voltage Uₘₐₓ is attained. After this, the cleaning appliance can be used by the operator. This happens in the period t₁ to t₂. During this period, the setpoint voltage Uₘₐₓ is maintained. If the cleaning appliance is switched off (time point t₂) and the electronic circuit is disconnected from the voltage source, the electronic circuit discharges. This is illustrated by the falling voltage curve. At the time point t₃, for example, there is the voltage Uₘᵢₙ in the electronic circuit. After that, the voltage continues to drop until it is completely discharged. U=0 therefore means U=0 V.

In order to avoid the heating means being supplied with power for the duration of t=0 to t₁ when the cleaning appliance is switched on and heating up being effected for this period of time, the actual temperature of the heating means can be checked and a shorter heating up can be effected in dependence on this. The check is effected, not by measuring the temperature in the heating means, but by matching it against the actual voltage in the electronic circuit.

If the actual voltage is between the limit voltage Uₘᵢₙ and the setpoint voltage Uₘₐₓ, for example, operation of the cleaning appliance can be effected directly without further preheating. This may be signaled to the operator by the use of generally known signals such as sound signals or displays. If the actual voltage is below the limit voltage Uₘᵢₙ, preheating must be effected. Preheating by the application of power to the heating means may be effected for a fixed time interval. In this case, a duration must be selected that ensures that at least the limit temperature Tₘᵢₙ is attained. The temperature characteristic curve shows that this is the interval t=0 to t0. Alternatively, the preheating may be effected for a variable time interval. The variable time interval in this case may be determined from the characteristic curves, which may be stored in the control unit of the cleaning appliance.

A temperature check may also be effected during operation of the cleaning appliance by sensing of the voltage on the model.

If the actual voltage is between Uₘᵢₙ and Uₘₐₓ, i.e. the actual temperature is between Tₘᵢₙ and Tₘₐₓ, intermediate heating may be initiated by the control unit.

FIG. 3 shows an embodiment of an electronic circuit as an RC element, or more precisely: with an RC element for the charging circuit, which represents heating, and an RC element for the discharging circuit, which represents cooling.

The left half of the circuit forms the charging circuit, having a voltage source U_{source}, a charging resistor R_{V} and the capacitor C. The right half forms the discharging circuit, having the capacitor C and the discharging resistor R_{L}. The voltage U is measured directly at the capacitor C. The charging circuit serves to represent the heating process, and the discharging circuit serves to represent the cooling process.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A cleaning appliance comprising:
a cleaning element;
a liquid container;
an electrically operated heater; and
a controller for controlling the heater, wherein the controller has an electronic circuit, and the electronic circuit is structured such that a thermal behavior of the heater is modeled therein, and
wherein a temperature characteristic of the heater is represented by a voltage characteristic in the electronic circuit.

2: The cleaning appliance as claimed in claim 1, wherein the electronic circuit comprises a plurality of electronic components and at least one electric energy store.

3: The cleaning appliance as claimed in claim 1, wherein electrical power, a thermal insulation of the heater and a heat storage capacity of the heater are represented in the electronic circuit.

4: The cleaning appliance as claimed in claim 1, wherein the electronic circuit is embodied as a PT1 element.

5: A method for controlling the cleaning appliance as claimed in claim 1, wherein the heater and the electronic circuit can be supplied with energy from an electrical power source,
wherein the electronic circuit is supplied with voltage when the heater is supplied with voltage,
wherein, when the cleaning appliance is activated, an actual voltage in the electronic circuit is checked, and
wherein, if the voltage is below a limit voltage, the heater is supplied with power to heat a liquid.

6: The method as claimed in claim 5, wherein, if the voltage is below the limit voltage, the heater is supplied with power for a duration of a fixed interval.

7: The method as claimed in claim 5, wherein, if the voltage is below the limit voltage, the heater is supplied with power for a duration of a variable interval, and the variable interval derives from a time that is expected until a setpoint voltage is attained.

8: The method as claimed in claim 7, wherein, if the voltage is below the setpoint voltage, the heater is supplied with power for the duration of the variable interval.

9: The method as claimed in claim 6, wherein in a next step a release signal is generated to signal that the cleaning appliance is ready for use.

10: The method as claimed in claim 7, wherein in a next step a release signal is generated to signal that the cleaning appliance is ready for use.

11: The cleaning appliance of claim 1, wherein the heater has a steam generator for heating a liquid.
